(19) United States
(12) Patent Application Publication
(10) Pub. No.: US 2026/0200796 A1
(43) Pub. Date: Jul. 16, 2026

(54) PROCESS FOR THE PRODUCTION OF AN ULTRA-LIGHT MINERAL FOAM

(71) Applicant: Amrize Technology Switzerland LLC, ZUG (CH)

(72) Inventor: Sébastien GEORGES, HOLDERBANK (CH)

(21) Appl. No.: 19/135,972

(22) PCT Filed: Dec. 8, 2023
(86) PCT No.: PCT/EP2023/084894

§ 371 Date: Jun. 5, 2025

(30) Foreign Application Priority Data
Dec. 9, 2022 (EP) 22306839.6

(51) Int. Cl. C04B 22/12; B28B 1/50; C04B 22/14; C04B 28/04; C04B 38/10; C04B 103/48; C04B 111/52

(52) U.S. Cl. CPC C04B 22/12; C04B 22/142; C04B 28/04; C04B 38/10; B28B 1/50; C04B 2103/48; C04B 2111/52; C04B 2201/20; C04B 2201/32

(57) ABSTRACT

A process for the production of a mineral foam includes (i) separately preparing a slurry of cement and an aqueous foam, wherein the cement slurry includes water (W) and Portland cement (C); (ii) contacting the slurry of cement with the aqueous foam to obtain a slurry of foamed cement; (iii) adding a transition metal salt before, during or after procedure (ii); (iv) casting the slurry of foamed cement and leaving it to set.

### FIELD OF THE INVENTION

The present invention refers to a process for the production of an ultra-light mineral foam, and to the use of the resulting mineral foam in elements of construction.

### BACKGROUND OF THE INVENTION

A mineral foam is a material in the form of foam. This material is generally more lightweight than typical concrete due to its pores or empty spaces. These pores or empty spaces are due to the presence of air in the mineral foam which may be in the form of bubbles. An ultra-light mineral foam is understood to having a density in its dry state comprised between 20 and 2000 kg/m³, preferentially between 20 and 600 kg/m³, and even more preferentially between 20 and 300 kg/m³.

Generally, a mineral foam, in particular a mineral foam made from a cement, is highly advantageous for many applications due its excellent thermal insulation properties, its acoustic insulation properties, its durability, its resistance to fire and its easy preparation and casting.

One of the main technical difficulties related to the preparation of a mineral foam is its stability before the cement sets, resulting in the foam becoming hard. After the freshly prepared mineral foam is poured into an element, it may slump due to a lack of stability. This may be due to coalescence of the bubbles, to a phenomenon of Ostwald ripening, to hydrostatic pressure, or to draining phenomena.

WO2017093795 and WO2017093797 disclose processes of production of mineral foams that makes use of a magnesium salt or an aluminium salt as a foam stabilizer.

There is still a need to provide a process and a formulation for an ultra-light and highly stable mineral foam, the realization of which is simple and incurs little cost.

### SUMMARY OF THE INVENTION

The invention is directed to a process for the production of a mineral foam comprising the following steps:
(i) separately preparing a slurry of cement and an aqueous foam, wherein the cement slurry comprises water (W) and Portland cement (C);
(ii) contacting the slurry of cement with the aqueous foam to obtain a slurry of foamed cement;
(iii) adding a transition metal salt before, during or after step (ii);
(iv) casting the slurry of foamed cement and leaving it to set.

The transition metal salt can be a manganese salt, preferably manganese chloride or manganese sulfate.

Preferably, the transition metal salt is added to the Portland cement before the addition of water in the preparation of the cement slurry in step (i).

Preferably, the transition metal salt is added to the cement slurry before contacting the cement slurry with the aqueous foam in step (ii).

Preferably, the transition metal salt is added in an amount comprised between 0.8% and 1.2% in weight of dry transition metal salt relative to the weight of cement.

The water/cement (W/C) ratio (weight/weight ratio of the cement slurry prepared in step (i) is preferably comprised between 0.30 and 0.40, more preferably between 0.32 and 0.38, and in particular 0.37.

Preferably, the cement slurry comprises at least one supplementary mineral component selected from calcium carbonate, silica, ground glass, solid or hollow glass beads, glass granules, expanded glass powders, silica aerogels, silica fume, slags, ground sedimentary siliceous sands, fly ash, pozzolanic materials or mixtures thereof.

The invention is directed to the use of a transition metal salt, in particular a manganese salt, in particular manganese chloride or manganese sulfate, in particular in the form of a manganese chloride solution or a manganese sulfate solution, for enhancing the mechanical stability and/or reducing the collapse of a slurry of foamed cement, said slurry of foamed cement being preferably obtained by:
(i) separately preparing a slurry of cement and an aqueous foam, wherein the cement slurry comprises water (W) and Portland cement (C);
(ii) contacting the slurry of cement with the aqueous foam to obtain a slurry of foamed cement;
(iii) adding a transition metal salt before, during or after step (ii).

Preferably, the transition metal salt is added in an amount comprised between 0.8% and 1.2% in weight of dry transition metal salt relative to the weight of cement.

The invention is also directed to the mineral foam obtained or obtainable according to the process described above having a density of 20 to 300 kg/m3.

Preferably, the mineral foam has a thermal conductivity of 0.030-0.150 W/(m·K).

The invention is directed to the use of the mineral foam described above as construction material or as insulating material.

The invention is also directed to an element of construction comprising a mineral foam as described above.

The process for the production of a mineral foam according to the invention may be used in a discontinuous or continuous system.

The process provided by the present invention has one or more of the following characteristics:
the process is universal, which is to say it makes it possible to produce a stable mineral foam from any type of cement;
the process is easy to implement and to use at an industrial scale;
the process can be easily transported to any site;
the process makes it possible to produce a mineral foam in a continuous manner. It is therefore possible to produce the mineral foam continuously and to place this foam without interruption.

The mineral foam provided by the instant invention has one or more of the following characteristics:
the mineral foam according to the invention has excellent stability properties. In particular, it is possible to obtain foam that does not slump or only very slightly when the foam is poured vertically or from a considerable height. For example, the mineral foam according to the invention did not slump or only very slightly when it is poured vertically from a height greater than or equal to 2 meters. In particular, compared to previous art compositions comprising aluminum salts or magnesium salts as foam stabilizers, the transition metal salts in the mineral foams according to the invention are more efficient foam stabilizers at low concentrations around 1% in dry salt by weight of cement;
the high stability of the mineral foam makes the preparation of lightweight mineral foams possible;
the mineral foam according to the invention has excellent thermal properties, and in particular very low thermal conductivity. Furthermore, this decrease makes it possible to reduce thermal bridges; in particular in the construction of buildings several stories high and designed using indoor thermal insulation. In particular thermal bridges are reduced on the intermediary floors.

### BRIEF DESCRIPTION OF THE FIGURES

FIG. 1 describes a particular embodiment illustrating a process according to the invention.

### DETAILED DESCRIPTION

### Definitions

Cement: a cement is a hydraulic binder comprising a proportion of at least 50% by weight of calcium oxide (CaO) and silicon dioxide (SiO₂). The cement is preferably a Portland cement as defined in the standard NF-EN-197-1 of April 2012. This standard defines several cement compositions that make use of Portland clinker, and optionally further comprise mineral components as defined below. The cement may be any mineral binder that comprises Portland clinker mixed with one or several mineral components as defined below. The cement may optionally further contain less than 10 wt.-% of a calcium aluminate cement or a calcium sulfoaluminate cement if shorter setting times and 30 higher early age strength development are for example required.
Mineral component: the mineral component may designate slag (for example, as defined in the European NF EN 197-1 Standard of April 2012, paragraph 5.2.2), pozzolanic materials (for example as defined in the European NE EN 197-1 Standard of April 2012, paragraph 5.2.3), fly ash (for example, as described in the European NF EN 197-1 Standard of April 2012, paragraph 5.2.4), calcined schists (for example, as described in the European NF EN 197-1 Standard of April 2012, paragraph 5.2.5), material containing calcium carbonate, for example limestone (for example, as defined in the European NF EN 197-1 Standard paragraph 5.2.6), limestone components (for example, as defined in the “Concrete” NF P 18-508 Standard), silica fume (for example, as defined in the European NF EN 197-1 Standard of April 2012, paragraph 5.2.7), siliceous components (for example, as defined in the “Concrete” NF P 18-509 Standard), metakaolin or mixtures thereof. The mineral component may also be ground construction demolition waste.
   Examples of siliceous components are ground glass, solid or hollow glass beads, glass granules, expanded glass powder.
Cement slurry: The expression “cement slurry” designates a mixture comprising water and cement. That cement slurry may also comprise additional components, as disclosed below. The terms “slurry of cement” and “cement slurry” have the same meaning and will be used interchangeably.
Aqueous foam: The expression “aqueous foam” designates a foam produced by combining water and a foaming agent then introducing a gas, generally air.
Foamed cement slurry: The expression “foamed cement slurry” designates a fresh foam comprising water and cement, mixed with gas bubbles, generally air. The foam will also comprise additional components, as disclosed below. The foamed cement slurry generally results from the mixing of a cement slurry and an aqueous foam. The foamed cement slurry is not produced from a gas-forming agent selected from hydrogen peroxide, peroxomonosulphuric acid, peroxodisulfphuric acid, alkaline peroxides, alkaline earth peroxides, organic peroxide, particles of aluminium, or mixtures thereof. The expressions “foamed cement slurry” and “fresh mineral foam” may be used interchangeably.
Mineral foam: a mineral foam is a set (i.e. hardened) foamed cement slurry. The expression “mineral foam” and “mineral cement foam” may be used interchangeably. The mineral foam of the invention is not an expanding foam, meaning is not a foam produced from a gas-forming agent selected from hydrogen peroxide, peroxomonosulphuric acid, peroxodisulfphuric acid, alkaline peroxides, alkaline earth peroxides, organic peroxide, particles of aluminium or mixtures thereof.

### 1. Process for the Production of a Mineral Foam

A first object of the invention is a process for the production of a mineral foam comprising the following steps:
(i) separately preparing a slurry of cement and an aqueous foam, wherein the cement slurry comprises water (W) and cement (C);
(ii) contacting the slurry of cement with the aqueous foam to obtain a slurry of foamed cement;
(iii) adding a transition metal salt before, during or after step (ii);
(iv) casting the slurry of foamed cement and leaving it to set. The transition metal salt is added before step (iv).

### Cement of Step (i)

The cement of step has the definition provided above.

The cement as used in the invention may be any type of cement comprising Portland clinker, whatever its chemical composition is, and in particular whatever its alkaline content.

Therefore, one of the advantages of the invention is not having to select a specific type of cement. Advantageously, the cement used in the invention is selected from the cements readily available on the market.

Advantageously the cement comprises at least 90 wt.-% of Portland clinker.

Advantageously, the cement has a specific surface (Blaine) of from 3000 to 10000 cm²/g, preferably from 3500 to 6000 cm²/g.

As mentioned above, the cement may comprise mineral components as defined above.

The mineral component is advantageously composed of particles that have a D50 generally comprised between 0.1 to 150 μm, preferably from 0.1 to 100 μm, more preferably from 1 μm and 20 μm.

The D50, also noted as Dv50, corresponds to the 50th percentile of the size distribution of the particles, by volume; that is, 50% of the particles have a size that is less than or equal to D50 and 50% of the particles have a size that is greater than D50.

Cements that are less or not suitable for the realization of the invention are calcium aluminate cements and their mixtures used alone. Calcium aluminate cements are cements generally comprising a mineral phase C4A3$, CA, C12A7, C3A or C11A7CaF2 or their mixtures, such as, e.g., Ciment Fondu® (a calcium aluminate-based hydraulic binder), alumina cements, sulfoaluminate cements and calcium aluminate cements according to the European NF EN 14647 Standard of December 2006. Such cements are characterized by an alumina (Al2O3) content equal or lower than 35 wt.-%. However, calcium aluminate cements, calcium sulfoaluminate cements, or mixtures thereof, may be used in small amounts if for example shorter setting times or increased early age strength is desired. Calcium aluminate cements, calcium sulfoaluminate cements, or mixtures thereof, may not exceed 10 wt.-% of the total cement.

Accordingly, preferably, the cement of the invention has an alumina (Al₂O₃) content lower or equal to 35 wt.-%.

### Cement Slurry of Step (i)

The water/cement (w/c) ratio (weight/weight ratio) of the cement slurry prepared in step (i) is preferably comprised between 0.30 and 0.40, more preferably between 0.32 and 0.38, and in particular 0.37.

The water/cement ratio may vary, for example due to the water demand of the mineral particles in the cement slurry, in case these are used. The water/cement ratio is defined as being the ratio by weight of the quantity of water (W) to the cement weight (C).

The cement slurry prepared in step (i) may further comprise a water reducer, such as a plasticiser or a super-plasticiser. A water reducer makes it possible to reduce the amount of mixing water for a given workability by typically 10-15% by weight.

Super-plasticisers are capable of reducing water contents of mixing water, for a given workability, by approximately 30% by weight.

By way of example of water reducers, mention may be made of lignosulphonates, hydroxycarboxylic acids, carbohydrates, and other specific organic for compounds, example glycerol, polyvinyl alcohol, sodium alumino-methyl-siliconate, sulfanilic acid and casein as described in the Concrete Admixtures Handbook, Properties Science and Technology, V. S. Ramachandran, Noyes Publications, 1984.

By way of example of a super-plasticiser, the PCP super-plasticisers without an anti-foaming agent may be noted. The term “PCP” or “polyoxy polycarboxylate” is to be understood according to the present invention as a copolymer of acrylic acids or methacrylic acids and their esters of polyoxy ethylene (POE) and/or polyoxy propylene.

Preferably, the cement slurry comprises 0.05 to 0.5 wt.-%, more preferably 0.05 to 0.2 wt.-% of a water reducer, a plasticizer or a superplasticizer, percentage expressed by weight relative to the dry cement weight.

Preferably, the cement slurry does not comprise an anti-foaming agent, or any agent having the property of destabilizing an air/liquid emulsion. Certain commercial super-plasticizers may contain anti-foaming agents and consequently these super-plasticizers are not suitable for the cement slurry used to produce the mineral foam according to the invention.

According to an embodiment of the invention, other additives may be added to the cement slurry or the aqueous foam. Such additives may be thickening agents, viscosity modifying agents, air entraining agents, setting retarders, or their mixtures. Preferably, the additives do not comprise any defoaming agents.

The expression “thickening agent”, is generally to be understood as any compound making it possible to maintain the heterogeneous physical phases in equilibrium or facilitate this equilibrium. The suitable thickening agents are preferably gums, cellulose or its derivatives, for example cellulose ethers or carboxy methyl cellulose, starch or its derivatives, gelatine, agar, carrageenans or bentonite clays.

The slurry of foamed cement may comprise a setting retarder. The retarder advantageously corresponds to the definition of the retarder mentioned in the European NF EN 934-2 Standard of September 2002. The retarder used according to the invention may for example be selected from:
sugars and derivative products, in particular, saccharose, glucose, sugar reducers (for example, lactose or maltose), cellobiose, galactose or derivative products, for example, glucolactone;
carboxylic acids or salts thereof, in particular gluconic acid, gluconate, tartric acid, citric acid, gallic acid, glucoheptonic acid, saccharic acid or salicylic acid. The associated salts comprise, for example, ammonium salt, alkali metal salt (for example sodium salt or potassium salt), alkali earth metal salt (for example calcium salt or magnesium salt). However, other salts may also be used;
phosphonic acids and salts thereof, in particular aminotri(methylenephosphonic) acid, pentasodic salt of aminotri(methylenephosphonic) acid, hexamethylene-diamine-tetra(methylene-phosphonic) acid, diethylene-triamine-penta(methylene-phosphonic acid and its sodium salt);
phosphates and their derivatives;
zinc salts, in particular zinc oxide, zinc borate and soluble zinc salts (nitrate, chloride);
borates, in particular boric acid, zinc borate and boron salts;
mixtures of these compounds.

The retarder may also be a carboxylic acid or a salt of carboxylic acid. According to an embodiment of the invention, the retarder is a citric acid or a salt thereof.

The slurry of foamed cement advantageously comprises 0.005 to 0.2% of retarder, more preferably 0.01 to 0.1%, in % by weight relative to the weight of slurry of foamed cement.

According to an embodiment of the invention, the cement slurry used to produce the mineral foam according to the invention may further comprise mineral components as described above.

The suitable mineral components are preferably selected from calcium carbonate, silica, ground glass, solid or hollow glass beads, glass granules, expanded glass powders, silica aerogels, silica fume, slags, ground sedimentary siliceous sands, fly ash, pozzolanic materials or mixtures thereof.

### Aqueous Foam of Step (i)

The aqueous foam of step (i) may comprise water (W) and a foaming agent.

In step (i), the aqueous foam may be produced by combining water and a foaming agent, then introducing a gas. This gas is preferably air. The foaming agent is preferably used in an amount of 0.25-5.00 wt.-%, preferably 0.75-2.50 wt.-%, (dry weight) of the weight of water.

The slurry of foamed cement may optionally comprise a co-stabiliser. The co-stabiliser is advantageously added in the aqueous foam of step (i), in particular in the aqueous solution comprising the foaming agent.

The introduction of air may be carried out by stirring, by bubbling or by injection under pressure. Preferably, the aqueous foam may be produced using a turbulent foamer (bed of glass beads for example). This type of foamer makes it possible to introduce air under pressure into an aqueous solution comprising a foaming agent.

The aqueous foam may be generated continuously in the process according to the invention.

Preferably, the foaming agent is an organic protein derivative of animal origin (such as, e.g., the foaming agent named Propump26, a powder of hydrolysed keratin, sold by the company Propump Engineering Ltd) or of vegetable origin. The foaming agents may also be a cationic surfactant (for example cetyltrimethylammonium bromide, CTAB), an ionic surfactant, an amphoteric surfactant (for example cocamidopropyl betaine, CAPB), or a nonionic surfactant, or mixtures thereof.

The co-stabiliser is preferably a polyelectrolyte, in particular a polyanion.

The co-stabiliser is preferentially a polymer having constitutional unit derived from unsaturated carboxylic acid monomer or anhydride thereof. The carboxylic acid monomer can be monocarboxylic acid monomer or dicarboxylic acid monomer. Examples thereof include:
acrylic acid, methacrylic acid; crotonic acid, maleic acid, fumaric acid, itaconic acid, and citraconic acid, and their monovalent metal salts, divalent metal salts, ammonium salts, and organic amine salts, and anhydride thereof;
esters, half esters and diesters of the above-mentioned unsaturated carboxylic acid monomers with alcohols having 1 to 12 carbon atoms, with alkoxy (poly)alkylene glycols, in particular with alkoxy (poly)ethylene glycol or with alkoxy (poly)propylene glycol;
amides, half amides and diamides of the above-mentioned unsaturated carboxylic acid monomers with amines having 1 to 30 carbon atoms, such as methyl(meth)acrylamide, (meth)acrylalkylamide, N-methylol(meth)acrylamide, and N,N-dimethyl(meth)acrylamide;
alkanediol of the above-mentioned unsaturated carboxylic acid monomers such as 1,4-butanediol mono(meth)acrylate, 1,5-pentanediol mono(meth)acrylate, and 1,6-hexanediol mono(meth)acrylate;
amines of the above-mentioned unsaturated carboxylic acid monomers such as aminoethyl (meth)acrylate, methylaminoethyl (meth)acrylate, dimethylaminoethyl (meth)acrylate, dimethylaminopropyl (meth)acrylate, and dibutylaminoethyl (meth)acrylate.

These monomers may be used either alone respectively or in combinations of two or more thereof. The monomer is in particular selected from acrylic acid, methacrylic acid, crotonic acid, maleic acid, fumaric acid, itaconic acid, and citraconic acid and anhydride thereof, in particular maleic anhydride, and mixtures thereof.

These monomers can also be copolymerised with hydrophobic monomers, in particular with:
vinyl aromatic monomers such as styrene, alpha-methylstyrene, vinyltoluene, and p-methylstyrene;
dienes such as butadiene, isoprene, 2-methyl-1,3-butadiene, and 2-chloro-1,3-butadiene;
1-alkenyl monomers having 2 to 12 carbon atoms, such as di-isobutylene.

The co-stabiliser is preferentially a copolymer of the above-mentioned unsaturated carboxylic acid monomers, or anhydride thereof, and of 1-alkenyl monomers having 2 to 12 carbon atoms, such as di-isobutylene. In particular the co-stabiliser is a copolymer of maleic anhydride and di-isobutylene.

The acid carboxylic function of the polymer is preferably totally or partially in a salt form. Advantageously the salt is a cation chosen from among the sodium, potassium, calcium, magnesium, ammonium, or their blends, preferentially chosen from among sodium or potassium and very preferentially sodium. In a preferred embodiment, the co-stabiliser is a sodium salt of a maleic anhydride copolymer, in particular a sodium salt of a maleic anhydride and di-isobutylene copolymer. An example of commercial product, commercialised by Dow, is TAMOL 731 A.

### Transition Metal Salt

According to the invention, a transition metal salt is added before, during or after step (ii), i.e. before, during or after contacting the slurry of cement with the aqueous foam to obtain a slurry of foamed cement. It has been observed that the transition metal salt is effective as an accelerator that accelerates that setting of the slurry of cement foam. In particular, the use of the transition metal salt specifically stabilizes Portland based mineral foam and limits water drainage in the foam before the cement slurry sets. Using transition metal salt consequently allows manufacturing highly stable Portland based mineral foam with pure cement. The addition of transition metal salt accelerators allows the manufacturing of highly stable ultra-low density mineral foams, and this independently of the type of Portland cement used.

The quality of the foam is improved. Notably, water drainage decreases when using transition metal salts.

Surprisingly, the transition metal salts prove to be more efficient foam stabilizers at low concentrations, around 1% in dry salt by weight of cement, preferably between 0.8% and 1.2% in dry transition metal salt by weight of cement, compared to previous art salts of magnesium or aluminium.

The transition metal salt is preferably added early in the process of the invention.

Among the transition metal salts, manganese salts are preferred.

Manganese chloride or manganese sulfate, in particular in the form of a manganese chloride solution or a manganese sulfate solution, are preferably used as manganese salt.

Manganese chloride or manganese sulfate can also be used as manganese salt in the form of a powder.

The manganese chloride that can be used, as a powder as such or as a powder prior its solubilization to obtain a salt solution, is in its anhydrous form or in a hydrate form, especially its dihydrate (MnCl₂·2H₂O) or its tetrahydrate (MnCl₂·4H₂O) forms.

The manganese sulfate that can be used, as a powder as such or as a powder prior its solubilization to obtain a salt solution, is in its anhydrous form or in a hydrate form, especially its monohydrate (MnSO₄·H₂O) or its tetrahydrate (MnSO₄·4H₂O) forms.

Preferably the transition metal salt is added to cement slurry, in particular before contacting the cement slurry with the aqueous foam in step (ii). The transition metal salt may b added during the preparation of the cement slurry or may be mixed with the Portland cement so as to obtain a premix that is used for subsequently preparing the cement slurry.

Preferably, the manganese salt is added in an amount comprised between 0.8% and 1.2% in weight of dry manganese salt relative to the weight of cement.

The use of other transition metal salts such as Cobalt or Nickel salts can be contemplated but are less preferred due their potential health risks.

The cement slurry may be prepared using mixers typically used to produce cement slurries. They may be a mixer for slurries, a mixer from a cement batching plant, a mixer described in the European NF EN 196-1 Standard of April 2006-Paragraph 4.4, or a beater with a planetary movement.

According to a first mode of operation, the cement slurry may be prepared by introducing into a mixer water, the transition metal salt (as a powder or in solution) and optionally additives (such as a water reducer). Thereafter, the Portland cement, and optionally other pulverulent components, is added into the mixer. The paste that is obtained in this way is then mixed for obtaining the cement slurry. Preferably, the cement slurry is kept under agitation for example by means of a deflocculating paddle at a speed which may be between 1000 and 600 rpm, depending on the volume of the slurry, during the entire manufacturing process.

According to a second mode of operation, the cement slurry may be prepared by introducing a part of the water, the transition metal salt (as a powder or in solution) and optionally the additives (such as a water reducer) in a mixer, and then the Portland cement and afterwards the further components.

According to a third mode of operation, the cement slurry may be prepared by introducing into a mixer the Portland cement, the transition metal salt as a powder and eventually all the others pulverulent components. The Portland cement, the transition metal salt and the pulverulent components are mixed in order to obtain a homogenous mixture. Water and optionally the additives (such as a water reducer) are then introduced into the mixer.

According to a fourth mode of operation, the cement slurry is prepared in a continuous way by preparing in advance a mixture containing the Portland cement, transition metal salt as a powder, water and additives (such as a water reducer).

The transition metal salt may be added to the aqueous foam, in particular before contacting the aqueous foam with the cement slurry in step (ii). The transition metal salt may be added during the preparation of the aqueous foam or may be mixed with the foaming agent so as to obtain a premix that is used for subsequently preparing the aqueous foam.

According to a particular embodiment, the total amount of the transition metal salt can be divided in several portions to be added in different steps of the process according to the invention.

### Foamed Cement Slurry

In step (ii), the cement slurry may be homogenized with the aqueous foam by any means to obtain a slurry of foamed cement.

The slurry of foamed cement may comprise water (W), Portland cement (C), a transition metal salt and a foaming agent. The Portland cement, the transition metal salt and the foaming agent are as described above.

Preferably, step (ii) of the process according to the invention may comprise the introduction of the cement slurry and the aqueous foam into a static mixer to obtain a slurry of foamed cement.

Examples of suitable static mixers are disclosed in WO2022/122760 (p. 14, 1.10-27).

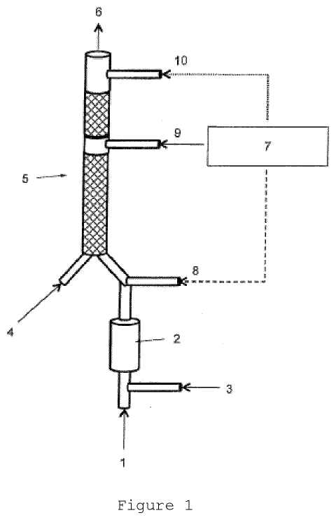

A particular embodiment illustrating a process according to the invention is represented on FIG. 1. A foaming solution (1) is supplied to a foamer (2) together with air (3). The aqueous foam produced in the foamer (2) and cement slurry (4) are brought into contact in a static mixer (5) and mixed in order to obtain a slurry of foamed cement (6). In a preferred embodiment, the cement slurry comprises transition metal salt. Preferably, the transition metal salt is present in the cement slurry (4) prior to its mixing with the aqueous foam produced in the foamer (2). In a preferred embodiment, a solution (7) of the transition metal salt may be added to the process, for example by means of a volumetric pump having an eccentric screw conveyor Seed™ MD 003-12 (commission no: 245928), at (8) (the solution (7) is added to the aqueous foam before the latter is conveyed into the static mixer (5); this embodiment is a preferred embodiment), at (9) (the solution (7) is added into the static mixer (5)), in particular into a middle region of the static mixer (5) and/or at (10) (the solution (7) is added to the slurry of foamed cement after the static mixer (5)).

### Foam Casting and Setting

This slurry of foamed cement is cast and left to set.

Advantageously, the inventive process does not need neither an autoclave step, nor a thermal treatment step (for example at 60-80° C.) in order to obtain a mineral foam according to the invention.

### 2. Mineral Foam

Further, the invention also relates to a mineral foam obtainable and/or obtained according to the process of the invention.

Preferably, the mineral foam obtained using, among other raw materials, powder raw materials that are substantially free of fine particles. The term materials that are free from “fine particles” is understood to be materials for which the mean diameter D50 of which is below 2 μm. The D50 diameter corresponds to the 50th percentile of the distribution by volume of the particle size, i.e. 50% of the volume is formed by particles having a size that is below the D50 diameter and 50% having a size that is above the D50 diameter. The term “substantially” means less than 18, preferably less than 5%, expressed in weight percentage of the cement weight.

Preferably, the mineral foam according to the invention may have a density of 20 to 300 kg/m³, preferably from 20 to 150 kg/m³, and even more preferably from 30 to 80 kg/m³. It is to be noted that the density of the slurry of foamed cement (humid density) is different to the density of the mineral foam (density of the hardened material).

The invention provides another advantage in that the mineral foam according to the invention has excellent thermal properties, and in particular very low thermal conductivity. Thermal conductivity (also called lambda (λ)) is a physical value characterizing the behaviour of materials during the transfer of heat by conduction. Thermal conductivity represents the quantity of heat transferred per unit of surface and per unit of time submitted to a gradient of temperature. In the international system of units, thermal conductivity is expressed in watts per metre Kelvin (W/m·K). Typical or conventional concretes have thermal conductivity values measured at 23° C. and 50% relative humidity of 1.3 to 2.1. The thermal conductivity of the mineral foam according to the invention with a dry density of 70 kg/m³ may be from 0.030 to 0.150 W/m·K, preferably from 0.030 to 0.060 W/m·K, more preferably from 0.030 to 0.055 W/m·K, the margin of error being ±0.4 mW/m·K.

Preferably, the mineral foam according to the invention has a very good fire resistance.

The mineral foam according to the invention may be a concrete, which is pre-cast on the jobsite, a ready-mix concrete or a concrete produced at a production plant of pre-cast elements. Preferably, the mineral foam according to the invention is a ready-mix concrete.

The mineral foam of the invention may be prefabricated. The mineral foam according to the invention may also be directly prepared on the jobsite by installing a foaming system on the jobsite.

The invention is also directed to an element of construction comprising a mineral foam as described above.

### 3. Use

The invention also relates to the use of the mineral foam according to the invention as construction material.

The mineral foam according to the invention may be used to cast walls, ceilings and roofs. It is also possible to realize prefabricated elements in a prefabrication plant, such as blocs or panels.

The invention also relates to the use of the mineral foam according to the invention as insulating material.

Advantageously, the mineral foam according to the invention may be used to fill empty or hollow spaces, a wall, a partition wall, a brick, a floor or a ceiling. In this case, it is used as a filling compound. Such composite construction elements also constitute objects of the invention per se.

Advantageously, the mineral foam according to the invention may be used as facade lining to insulate a building from the outside. In this case, the mineral foam according to the invention may be coated by a finishing compound.

The invention also relates to a system comprising the mineral foam according to the invention. The mineral foam may be present in the system, for example as insulating material. The system according to the invention is a system capable of resisting to transfers of air.

The system according to the invention may be used to produce a lining, an insulation system or a partition wall, for example a separation partition wall, a distribution partition wall or an inner partition.

The mineral foam according to the invention may be used to fill hollow parts of building blocks, such as cavity bricks. The foam may be filled into the cavity at any production step of the building bloc.

The mineral foam according to the invention may be cast vertically between two walls, for example between two concrete walls or two brick walls to obtain a system.

The invention also relates to the use of a transition metal salt, in particular a manganese salt, in particular manganese chloride or manganese sulfate, in particular in the form of a manganese chloride solution or a manganese sulfate solution, for enhancing the mechanical stability and/or reducing the collapse of a slurry of foamed cement, said slurry of foamed cement being preferably obtained by:
(i) separately preparing a slurry of cement and an aqueous foam, wherein the cement slurry comprises water (W) and Portland cement (C);
(ii) contacting the slurry of cement with the aqueous foam to obtain a slurry of foamed cement;
(iii) adding a transition metal salt before, during or after step (ii).

Preferably, the transition metal salt is added in an amount comprised between 0.8% and 1.2% in weight of dry transition metal salt relative to the weight of cement.

The invention will now be described by reference to the following non limitative examples.

The measuring methods used in the examples are now detailed below.

### Laser Granulometry Method

In this specification, including the accompanying claims, particle size distributions and particle sizes are as measured using a laser granulometer of the type Mastersize 2000 (year 2008, series MAL1020429) sold by the company Malvern.

Measurement is effected in an appropriate medium (for example an aqueous medium for non-reactive particles, or alcohol for reactive material) in order to disperse the particles. The particle size shall be in the range of 1 μm to 2 mm. The light source consists of a red He—Ne laser (632 nm) and a blue diode (466 nm). The optical model is that of Frauenhofer and the calculation matrix is of the polydisperse type. A background noise measurement is effected with a pump speed of 2000 rpm, a stirrer speed of 800 rpm and a noise measurement for 10 s, in absence of ultrasound. It is verified that the luminous intensity of the laser is at least equal to 80% and that an decreasing exponential curve is obtained for the background noise. If this is not the case, the cell's lenses have to be cleaned.

Subsequently, a first measurement is performed on the sample with the following parameters: pump speed 2000 rpm and stirrer speed 800 rpm. The sample is introduced in order to establish an obscuration between 10 and 20%. After stabilisation of the obscuration, the measurement is effected with a duration between the immersion and the measurement being fixed to 10 s. The duration of the measurement is 30 s (30000 analysed diffraction images). In the obtained granulogram one has to take into account that a portion of the powder may be agglomerated.

Subsequently, a second measurement is effected (without emptying the receptacle) with ultrasound. The pump speed is set to 2500 rpm, the stirrer speed is set to 1000 rpm, the ultrasound is emitted at 100% (30 watts). This setting is maintained for 3 minutes, afterwards the initial settings are resumed: pump speed at 2000 rpm, stirrer speed at 800 rpm, no ultrasound. At the end of 10 s (for possible air bubbles to clear), a measurement is carried out for 30 s (30000 analysed images). This second measurement corresponds to a powder desagglomerated by an ultrasonic dispersion.

Each measurement is repeated at least twice to verify the stability of the result.

### Measurement of the Specific BLAINE Surface

The specific surface of the various materials is measured as follows. The Blaine method is used at a temperature of 20° C. with a relative humidity not exceeding 65%, wherein a Blaine apparatus Euromatest Sintco conforming to the European Standard EN 196-6 is used.

Prior to the measurement the humid samples are dried in a drying chamber to obtain a constant weight at a temperature of 50-150° C. The dried product is then ground in order to obtain a powder having a maximum particle size of less than or equal to 80 μm.

### Measurement of Thermal Conductivity

Thermal conductivity is measured following the protocol given in ASTM C1113 (2019).

### Measurement of Water Drainage

In order to measure water drainage, a cylindrical container of 16 cm diameter by 32 cm height is filled with a freshly prepared slurry of foamed cement.

Two 8 mm holes are made in the base of the cylinder to collect the water that drains out of the slurry of foamed cement before the cement sets.

Once the cement sets, the cylindrical container is cut open, and the weight of the mineral foam and of the water collected is measured.

Water drainage is expressed in grams of water collected.

### EXAMPLES

### Materials

The cement used is a CEM I 52.5R supplied by Lafarge Austria. The plasticizer is TAL Airium Fluid supplied by TAL BETONCHEMIE. The salt is a manganese salt in the examples according to the invention or another salt in the comparative examples.

The manganese salt is either MnCl₂ supplied by Sigma Aldrich, in anhydrous form or MnSO₄ supplied by Sigma Aldrich, in dry form.

The other salts are:
aluminium sulphate (Al₂(SO₄)₃) is either aluminum sulphate hydrate supplied by the company Sigma-Aldrich under the product name Sulfate d′aluminium, 14 H2O recapture from Sigma or the product SIKA 40AF supplied by the company Sika.
magnesium chloride (MgCl₂) is supplied by the company Sigma-Aldrich
sodium chloride (NaCl) is supplied by the company Sigma-Aldrich
calcium chloride (CaCl₂) is supplied by the company Sigma-Aldrich
zinc chloride (ZnCl₂) is [DB1] supplied by the company Sigma-Aldrich

The foaming agents used are the following derivative proteins of animal origin:
Propump 26 obtained from the company Propum Engineering Ltd having a solids content of 26 wt.-%
MAPEAIR L/LA obtained for the company MAPEI, having a solids content of 26 wt.-%.

Water: tap water

### Equipment

### The Rayneri Mixer:

A Turbotest mixer (MEXP-101, model: Turbotest 33/300, Serial No: 123861) supplied by the company Rayneri, which is a mixer with a vertical axis.

### Pumps:

A pump having an eccentric screw conveyer Seepex™ of the type MD 006-24, commission no. 244920.
A pump having an eccentric screw conveyer Seepex™ of the type MD 006-24, commission no. 278702.

### Foamer:

A foamer comprising a bed of glass beads of the type SB30 having a diameter of 0.8-2.5 mm filled up in a tube having a length of 100 mm and a diameter of 12 mm.

### Static Mixer:

A static mixer comprised of 32 helicoidal elements of the type Kenics having a diameter of 19 mm and referred to as 16La632 at ISOJET.

### Preparation of Cement Slurry

For preparing one liter of slurry having a water/cement ratio of 0.37, the following composition was used:

TABLE 1

| | Amount (g) |
|---|---|
| Portland cement (CEM I 52.5R) | 996 |
| Superplasticizer | 5.68 |
| Tap water | 364 |

The composition also includes salt in the amounts relative to the cement as indicated in Table 3.

The cement slurry has been prepared by using the mixer Rayneri Turbotest 33/300, into which tap water has first been introduced. While mixing at 1000 rpm, the solid components have progressively been added. The cement slurry was then mixed for two additional minutes.

### Preparation of the Foaming Solution

A foaming solution, i.e. an aqueous solution containing the foaming agents, was prepared using the following amounts of materials.

### For One Liter of Foaming Solution:

| | | |
|---|---|---|
| MAPEAIR L/LA | 25 | g |
| TAMOL 731 A (from DOW) | 2 | g |
| Tap water | 973 | g |

The foaming solution was pumped by means of a volumetric pump having an eccentric screw conveyor Seed™ MD-006-24 (commission no: 278702).

This foaming solution was introduced into the foamer through the bed of beads by means of pressurized air (1-6 bar) and a T-junction. The aqueous foam was produced in a continuous way at a rate of 8 litres per minute, having a density of 45 kg/m³.

### Preparation of the Fresh Mineral Foam

The aqueous foam as previously obtained, was brought into contact with the cement slurry each other in a static mixer and a slurry of foamed cement was obtained. The flow rate of the aqueous foam into the static mixer is of 377 g per minute.

The slurry rate is adjusted to obtain the target density of 70 kg/m³.

### Preparation of Mineral Foam Cubes

The slurry of foamed cement was poured into cubes made of polystyrene having a dimension of 10×10×10 cm.

### The Results

The results are presented in Table 3.

TABLE 3

| | Salt - concentration | Water drainage - |
|---|---|---|
| Mineral foam | dry wt %/ cement | 6 hours (g) |
| A | — | 182 |
| B | 1% Al₂(SO₄)₃ | 82 |
| C | 1.25% Al₂(SO₄)₃ | 24.5 |
| D | 1% MgCl₂ | 45 |
| E | 1.5% MgCl₂ | 20 |
| F | 1% NaCl | 147 |
| G | 1.5% NaCl | 220 |
| H | 1% CaCl₂ | 200 |
| I | 1.5% CaCl₂ | 198 |
| J(I) | 1% MnCl₂ | 32 |
| K1(I) | 1.5% MnCl₂ | 20 |
| K2(I) | 1.5% MnCl₂ | 20 |
| L(I) | 2% MnCl₂ | 15 |
| M(I) | 1% MnSO₄ | 25 |
| N(I) | 1.5% MnSO₄ | 20 |
| O | 1% ZnCl₂ | 168 |
| P | 1.5% ZnCl₂ | 175 |

The mineral foams J, K1, K2 (reproduction of K1), L, M and N are mineral foams according to the invention. The results show that they exhibit a lower water drainage highlighting an increased stability of the foam.

At a concentration of 1% in dry manganese salt by weight of cement, the manganese salts prove to be more efficient as foam stabilizers than all the other metal salts tested.

1. A method for the production of a mineral foam comprising the following steps:
(i) separately preparing a cement slurry and an aqueous foam, wherein the cement slurry comprises water (W) and Portland cement (C);
(ii) contacting the cement slurry with the aqueous foam to obtain a slurry of foamed cement;
(iii) adding a transition metal salt before, during or after step (ii);
(iv) casting the slurry of foamed cement and leaving it to set.

2. The method according to claim 1, wherein the transition metal salt is a manganese salt.

3. The method according to claim 1, wherein the transition metal salt is added to the Portland cement before the addition of water in the preparation of the cement slurry in step (i).

4. The method according to claim 1, wherein the transition metal salt is added to the cement slurry before contacting the cement slurry with the aqueous foam in step (ii).

5. The method according to claim 1, wherein the transition metal salt is added in an amount comprised between 0.8% and 1.2% in weight of dry transition metal salt relative to the weight of cement.

6. The method according to claim 1, wherein the water/cement (W/C) ratio (weight/weight ratio) of the cement slurry prepared in step (i) is comprised between 0.30 and 0.40.

7. The method according to claim 1, wherein the cement slurry comprises at least one supplementary mineral component selected from calcium carbonate, silica, ground glass, solid or hollow glass beads, glass granules, expanded glass powders, silica aerogels, silica fume, slags, ground sedimentary siliceous sands, fly ash, pozzolanic materials or mixtures thereof.

8. A method comprising utilizing a transition metal salt for enhancing the mechanical stability and/or reducing the collapse of a slurry of foamed cement, said slurry of foamed cement being obtained by:
(i) separately preparing a cement slurry and an aqueous foam, wherein the cement slurry comprises water (W) and Portland cement (C);
(ii) contacting the cement slurry with the aqueous foam to obtain a slurry of foamed cement;
(iii) adding the transition metal salt before, during or after step (ii).

9. The method according to claim 8, wherein the transition metal salt is added in an amount comprised between 0.8% and 1.2% in weight of dry transition metal salt relative to the weight of cement.

10. The mineral foam obtained or obtainable according to claim 1 having a density of 20 to 300 kg/m³.

11. The mineral foam according to claim 10 having a thermal conductivity of 0.030-0.150 W/(m·K).

12. A method comprising utilizing the mineral foam according to claim 10 as construction material or as insulating material.

13. An element of construction comprising a mineral foam according to claim 10.

14. The process according to claim 2, wherein the manganese metal salt is manganese chloride or manganese sulfate.

15. The process according to claim 6, wherein the water/cement (W/C) ratio (weight/weight ratio) of the cement slurry prepared in step (i) is comprised between 0.32 and 0.38.

16. The process according to claim 15, wherein the water/cement (W/C) ratio (weight/weight ratio) of the cement slurry prepared in step (i) is 0.37.

17. The method according to claim 8, wherein the transition metal salt is a manganese salt.

18. The method according to claim 17, wherein the manganese salt is manganese chloride or manganese sulfate.

19. The method according to claim 18, comprising utilizing a manganese chloride solution or a manganese sulfate solution.
